(19) United States
(12) Patent Application Publication
(10) Pub. No.: US 2023/0153658 A1
(43) Pub. Date: May 18, 2023

(54) AUTOMATIC GENERATION OF EXPLANATIONS FOR ALGORITHM PREDICTIONS

(71) Applicant: Shanghai United Imaging Intelligence Co., LTD., Xuhui District (CN)

(72) Inventors: Ziyan Wu, Cambridge, MA (US); Yunhao Ge, Cambridge, MA (US); Meng Zheng, Cambridge, MA (US); Srikrishna Karanam, Cambridge, MA (US); Terrence Chen, Cambridge, MA (US)

(73) Assignee: Shanghai United Imaging Intelligence Co., LTD., Xuhui District (CN)

(21) Appl. No.: 17/525,313

(22) Filed: Nov. 12, 2021

(51) Int. Cl. G06N 5/04; G06F 11/30

(52) U.S. Cl. CPC G06N 5/045; G06F 11/302; G06F 11/3086

(57) ABSTRACT

Automatically generating an explanation for a decision prediction from a machine learning algorithm includes using a first processor of a computing device to run the machine learning algorithm using one or more input data; generating a decision prediction output based on the one or more input data; using a second processor to access the decision prediction output of the first processor; generating additional information that identifies one or more causal relationships between the prediction of the first algorithm and the one or more input data; and providing the additional information as the explanation in a user-understandable format on a display of the computing device.

### FIELD

The aspects of the disclosed embodiments relate generally to machine learning systems and more particularly to generating explanations for predictions made by a machine learning system.

### BACKGROUND

With the increased use of machine learning in areas ranging from security to medicine, it is critical that the algorithms used for decision predictions are transparent and explainable, as this relates directly to the trust of the end-user in and of the algorithm. Currently, most systems and applications present decision predictions without any explanations.

Some systems and applications use explainable artificial intelligence (xAI) approaches to explain the predictions of the corresponding algorithms. Most recent xAI approaches attempt to explain the decision reasoning process with visualizations depicting the correlation between input pixels (or low-level features) and the final output. However, there are some key limitations with these methods.

First, the resulting explanations are limited to low-level relationships and do not provide an in-depth reasoning for model inference. Second, these methods do not have systematic processes to verify the reliability of the proposed model explanations. Finally, they do not offer guidance on how to correct mistakes made by the original model. It would be advantageous to be able to receive a human understandable explanation as to the reasons or reasoning underlying a decision prediction or other output generated by a machine learning algorithm.

Accordingly, it would be desirable to provide methods and apparatus that address at least some of the problems described above.

### SUMMARY

The aspects of the disclosed embodiments are directed to a method, apparatus and system to automatically generate explanations for decision predictions that are generated by a machine learning algorithm. This and other advantages of the disclosed embodiments are provided substantially as shown in, and/or described in connection with, at least one of the figures, as set forth in the independent claims. Further advantageous modifications can be found in the dependent claims.

According to a first aspect, the disclosed embodiments provide a method for generating explanations for predictions generated by a machine learning algorithm, the method including using a first hardware processor to run a machine learning algorithm using input data; generate a prediction output based on the one or more input data; using a second hardware processor to access the prediction output of the first algorithm as well as the input data, and generate additional information that reveals one or more causal relationships between the prediction output of the first algorithm and the input data. The aspects of the disclosed embodiments provide a human understandable explanation of the reasoning behind a decision prediction made by the machine learning process. In addition to providing an in-depth understanding and precise causality of the inference process used by the machine learning algorithm, the aspects of the disclosed embodiments can also help diagnose errors in the original model and improve the performance of the machine learning algorithm.

In a possible implementation form, generating the additional information includes identifying primitive concepts in the input data; establishing a representation for objects-of-interest using the identified primitive concepts and relationships between the objects-of-interest; calculating correlations between the decision prediction output and each component in the representation; converting the calculated correlations to causal importance scores; and presenting a visualization of the casual importance scores on a user interface of the computing device. The aspects of the disclosed embodiments are directed to identifying the causal relationships between the input data of the machine learning algorithm and the prediction output, and enabling a visualization of the relationships in a human understandable manner.

In a possible implementation form, the machine learning algorithm includes one or more of mathematical formulas, statistical models, machine learning models or neural networks.

In a possible implementation form, the second processor has access to the machine learning algorithm being run by the first processor. Having access the machine learning algorithm being run by the first processor will improve the reliability of the machine learning algorithm being run by the second processor.

In a possible implementation form, the second processor does not have access to the machine learning algorithm being run by the first processor. Maintaining this separation can preserve the privacy of the machine learning algorithm being run by the first processor.

In a possible implementation form, the second processor has access to the one or more input data. Access to the input data to the machine learning algorithm being run by the first processor allows the second processor identify correlations and relationships between the input data and the prediction output data.

In a possible implementation form, the second processor does not have access to the one or more input data. This can preserve the privacy of the data accessed by the first processor. The second processor can work given intermediate representations output from the first processor and provide explanations given those intermediate representations.

In a possible implementation form, the causal relationships can be the spatial correlations between the output of the machine learning algorithm and the input data. Pixel locations of visual concepts can be relied upon to understand their spatial correlations.

In a possible implementation form, the causal relationships can be temporal correlations between the output of the machine learning algorithm and the input data. Different time stamps of visual concepts can be relied upon to understand their temporal correlations.

In a possible implementation form, the causal relationships are a structural representation of different components sharing causal relationships with the input data, or the output of the machine learning algorithm. Generally, the correlation between each component and the output can be calculated to determine the causal relationships.

In a possible implementation form, a computer assisted medical diagnosis system generates diagnosis-related predictions, and at the same time automatically provides reasoning or evidence to support the generated predictions.

In a possible implementation form, a quality control system generates quality assessment of a product, and at the same time automatically provides reasoning or evidence to support the generated assessment. This can include identifying which part of the product failed the test and the severity of the failure.

In a possible implementation form, the generated casual relationships can be used to evaluate the performance of a machine learning algorithm on a first process.

In a possible implementation form, the generated casual relationships can be used to identify defects, limitations or other kinds of shortcomings of the machine learning algorithm on the first process.

In a possible implementation form, the generated casual relationships can be corrected, either automatically by another algorithm, or manually by a user. The correction can then be used to improve the performance of the machine learning algorithm.

In a possible implementation form, the generated casual relationships can be used as constraints, guidance, supervision, or auxiliary information in the training of other machine learning algorithms.

In a possible implementation form, the casual relationships generated by the second processor is based on imitative training of another machine learning algorithm with access to the machine learning algorithm run by the first processor.

In a possible implementation form, the causal explanations generated by the second processor can be used to extend the application, capabilities or functionalities of the machine learning algorithm run by the first processor.

According to a second aspect, the disclosed embodiments provide an apparatus for generating explanations for predictions generated by a machine learning algorithm. In one embodiment, the apparatus includes a first processor that is configured to run a machine learning algorithm using one or more input data and generate a prediction output based on the one or more input data. A second processor is configured to access the prediction output of the first algorithm and generate additional information that reveals one or more causal relationships between the prediction output of the first algorithm and the input data. The aspects of the disclosed embodiments provide a human understandable explanation of the reasoning behind a decision prediction made by the machine learning process. In addition to providing an in-depth understanding and precise causality of the inference process used by the machine learning algorithm, the aspects of the disclosed embodiments can also help diagnose errors in the original model and improve the performance of the machine learning algorithm.

According to a third aspect the disclosed embodiments are directed to a computer program product with a non-transitory computer-readable medium having machine readable instructions stored thereon, which when executed by a computer cause the computer to use a first processor to run a machine learning algorithm using one or more input data; generate a prediction output based on the one or more input data and use a second processor to access the prediction output of the first algorithm and generate additional information that reveals one or more causal relationships between the prediction output of the first algorithm and the one or more input data.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the aspects of the disclosed embodiments will be explained in more detail with reference to the example embodiments shown in the drawings, in which:

FIG. 1 is a block diagram of an exemplary apparatus in accordance with the aspects of the disclosed embodiments.

FIG. 2 is a diagram of an exemplary workflow in accordance with the aspects of the disclosed embodiments.

FIG. 3 is a diagram of an exemplary workflow incorporating aspects of the disclosed embodiments.

FIG. 4 is a block diagram of exemplary components of a computing apparatus in accordance with the aspects of the disclosed embodiments.

### DETAILED DESCRIPTION OF THE DISCLOSED EMBODIMENTS

The following detailed description illustrates exemplary aspects of the disclosed embodiments and ways in which they can be implemented. Although some modes of carrying out the aspects of the disclosed embodiments have been disclosed, those skilled in the art would recognize that other embodiments for carrying out or practising the aspects of the disclosed embodiments are also possible.

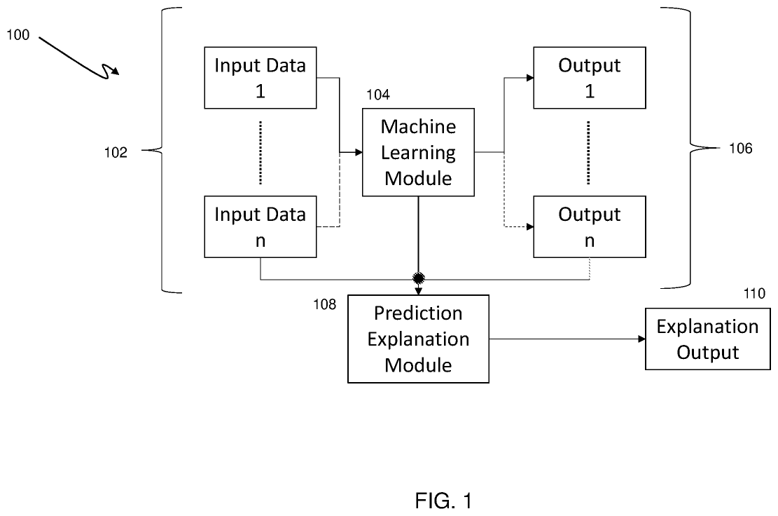

Referring to FIG. 1, an apparatus 100 for generating explanations for predictions generated by a machine learning model or algorithm is illustrated. In one embodiment, the apparatus 100 comprises for example, a computing device that is configured to run or execute one or more machine learning algorithms. For the purposes of the description herein, a machine learning algorithm, model or process will generally be referred to as a machine learning model. The aspects of the disclosed embodiments are directed to providing a human understandable explanation or visualization of the reasoning behind a decision prediction made by the machine learning model. In addition to providing an in-depth understanding and precise causality of the inference process used by the machine learning model, the aspects of the disclosed embodiments can also help diagnose errors in the original model and improve the performance of the model.

As is illustrated in FIG. 1, the apparatus 100 includes a machine learning module 104. The machine learning module 104, which in one embodiment comprises a machine learning algorithm, is generally configured to receive input data 102, referred to in this example as input data 1 to input data n. The machine learning module 104 will calculate an output 106 based on the input 102. In the examples herein, the output 106 is referred to as a decision prediction and referenced in FIG. 1 as Output 1 to Output n. As will be generally understood, the output 106 will generally comprise a decision prediction of the algorithm running in the machine learning module 104, based on the input data 102.

The apparatus 100 also includes a prediction explanation module 108. The prediction explanation module 108 is generally configured to access the input 102, the output 106 and generate additional information that reveals one or more causal relationships between the output 106 and the input 102. The explanation output 110 is the additional information from the prediction explanation module 108 and identifies a causal or structural relationship in the input data 102 to explain the reasoning for the output 106. The explanation output 110 is presented in a human understandable manner.

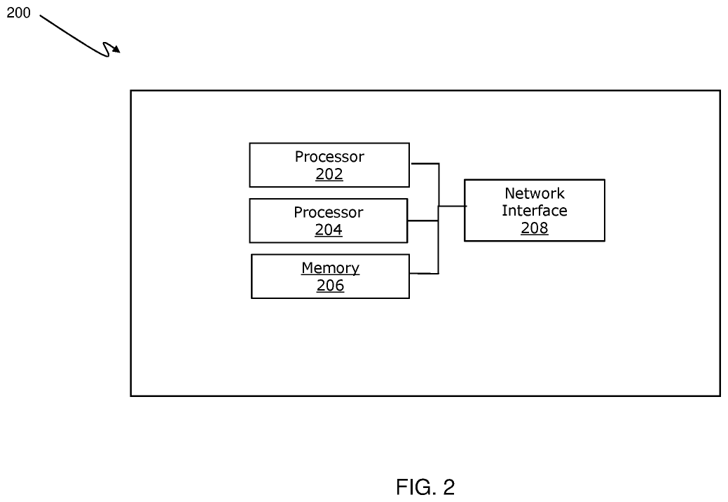

FIG. 2 is a block diagram of an exemplary apparatus 200 for generating explanations for algorithm predictions in accordance with the aspects of the disclosed embodiments. The apparatus 200 generally includes a first processor 202 and a second processor 204. Although a first processor 202 and a second processor 204 are described herein, the aspects of the disclosed embodiments are not so limited. In alternate embodiments, the first processor 202 and the second processor 204 can comprise a single processor or processing device or be part of the same computing device. In alternate embodiments, the first processor 202 and the second processor 204 can be on different computing devices. In one embodiment, the first processor 202 and the second processor 204 comprise hardware processors.

With reference also to FIG. 1, the machine learning module 104 will generally comprise or otherwise be coupled to the first processor 202. The first processor 202 is configured to run the machine learning algorithm of the machine learning module 104 using the input data 102. The first processor 202 will implement the machine learning algorithms of the machine learning module 104 and generate the model inference or output 106.

Also, with reference to FIG. 2, in one embodiment, the prediction explanation module 108 includes or is coupled to the second processor 204. For example, in one embodiment, the second processor 204 is configured to run the algorithm(s) of the prediction explanation module 108 by accessing at least the output 106 of the machine learning module 104, as well as the inputs 102 and generate the explanation output 110. The explanation output 110 will identify or reveal one or more causal relationships between the prediction output 106 of the first machine learning module 104 and input data 102.

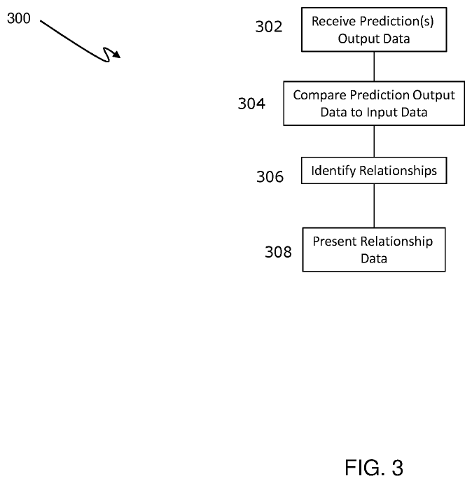

FIG. 3 illustrates one example of a workflow incorporating aspects of the disclosed embodiments. In this example, a machine learning algorithm implemented by the machine learning module 104 of FIG. 1, has generated output 106. This output, also referred to as a “prediction” or “decision prediction” is received 302 by the prediction explanation module 108.

The prediction decision output 106 from the machine learning module 104 is compared 304 or analysed with respect to the input data 102. In one embodiment, this analysis or comparison 304 includes producing gradients from the prediction decision output 106 with respect to each visual concept of the input data 102 and ranking the importance of these visual concepts by the value of the gradients.

From the comparison 304, relationships between the input data and the output, the prediction data, are identified 306. The relationship data can be presented 308 to the user in a human understandable manner. For example, in one embodiment, an explanation of the reasoning to arrive at the prediction decision 106 can be presented, such as on a user interface of a computing device.

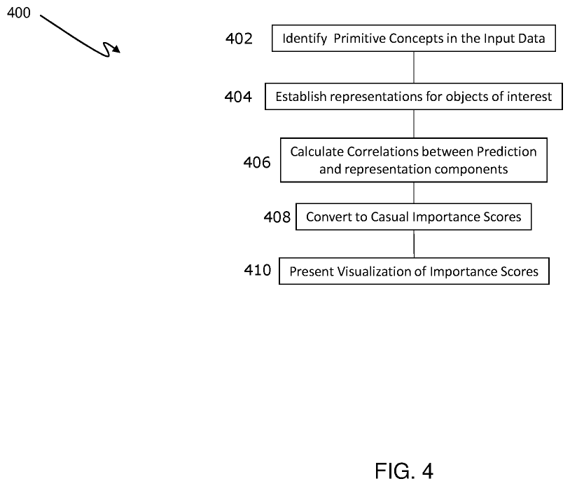

FIG. 4 illustrates a flowchart of an exemplary method 400 incorporating aspects of the disclosed embodiments. In this example, the method 400 is directed to generating the additional information that identifies the one or more causal relationships between the prediction output 106 of the machine learning algorithm 104 and the input data 102. In one embodiment, primitive concepts in the input data 102 are identified 402. Primitive concepts can generally be considered visual concepts that are extracted from the input data. Take an image as an example. In this example, the visual concepts will usually comprise groups of pixels that are representative for identifying the object of interest. An image with a jeep car (object of interest) in the foreground, is classified as “jeep car” by the first processor. The primitive concepts can be groups of image pixels (part/component of the foreground object in the input image), containing for example, the jeep logo on the car, the wheels and/or the windows, among other aspects of the car.

Representations are established 404 for objects-of-interest using the primitive concepts and the relationships between the primitive concepts. As explained above, for an image labeled or classified as a certain class (e.g., jeep car), the image itself may contain unrelated background objects (e.g., a person, road, etc). The object-of-interest in this example refers to the jeep car itself. The term “representations” here refers to feature vectors which are projected to a learned feature space from the visual concepts by running inference by a machine/deep learning model. This feature vector then can be used to represent the visual concept in the learned feature space.

Correlations are calculated 406 between the prediction output(s) 106 and each component in the representation and the calculated correlations are converted 408 to causal importance scores. For example, the correlations between input concept representations and prediction output can be mathematically quantified to certain values, normalized between 0 to 1. A correlation value of 0 means no correlation (the input concept does not contribute or is not related to model prediction). A correlation value of 1 indicates closely correlated. This correlation value can be calculated from the produced gradients from the prediction output 106.

In one embodiment, the converted causal importance scores are configured to be visualized 410 in a human-understandable manner. For example, in one embodiment, the converted causal importance scores are presented on a user interface of an associated computing device. Representations and primitive concepts will correspond to each other (i.e., a one-to-one correspondence). After the casual importance scores of each concept representation are generated, those primitive concepts can be shown to the user via the user interface of the computing device, with decreasing/increasing casual importance scores. The actual ranking order does not need to be presented. Rather, in one embodiment, the concepts with corresponding casual importance scores can be presented.

Referring again to FIGS. 1 and 2, in one embodiment, either alone or in combination with any one or more of the embodiments described herein, the second processor 204 that is running the algorithm of the prediction explanation module 108 has access to the machine learning algorithm being run by the first processor 202 associated with the machine learning module 104.

In one embodiment, either alone or in combination with any one or more of the embodiments described herein, the second processor 204 that is running the algorithm of the prediction explanation module 108 does not have access to the machine learning algorithm of the machine learning module 104 being run by the first processor 202. In this manner the operations and workflow of the first processor 202 will not affect the performance and workflow of the second processor 204. The separation between the first processor 202 and the second processor 204 will also preserve the privacy of the machine learning algorithm being run by the first processor 202.

In one embodiment, either alone or in combination with any one or more of the embodiments described herein, the second processor 202 has access to the input data 102. Access to the input data 102 allows the second processor 202 to directly compare the input data 102 to the output data 106 for the analysis. This allows for ranking the importance of the visual concepts by the value of the determined gradients as described above.

In one embodiment, either alone or in combination with any one or more of the embodiments described herein, the second processor 202 does not have access to the input data 102. In this example, the second processor 202 only has access to an intermediate representation of the input 102. Otherwise, the assessment is done in a similar as described above. This separation maintains the privacy of the input data to the machine learning algorithm 104.

In one embodiment, either alone or in combination with any one or more of the embodiments described herein, the causal relationships that are identified by the prediction explanation module 108 are spatial correlations between visual concepts of the input data 102. The spatial correlations can be used to identify patterns or other important visual concepts or cues in the input data that are used to form the decisions.

For example, a given number of images belong to different classes. The input images are segmented into groups of pixels, also referred to herein as “visual concepts.” The groups of pixels are input into a learned machine/deep model, such as the model implemented by the prediction explanation module 108. The top “n” visual concepts can be selected based on the output of the machine/deep model by ranking the score each visual concept corresponds to. This ranking is presented by the explanation output 110.

For example, the identification of visual patterns can be used to explain why an input image is a cat, or why an input image is not a dog. This can include identifying characteristics that are associated with cats and characteristics that are associated with dogs. The correlation of the visual aspects of the respective characteristics to the output data 106 is used to generate the explanation output 110.

In one embodiment, either alone or in combination with any one or more of the embodiments described herein, the identified causal relationships can be temporal correlations between the output 106 and the input data 102. For example, when recognizing different activities like basketball and tennis in a video input, visual concepts like hand and legs can be identified from the video input data 102. The hands and legs in a basketball game will move differently over time than they may in a tennis match. Thus, while hands and legs belong to the same set of visual concepts, the different sets will move differently over time in different activities. Thus, the temporal correlations or relationships will be different.

In one embodiment, either alone or in combination with any one or more of the embodiments described herein, the identified causal relationships can be a structural representation of different components sharing causal relationships with the input data 102, or the output 106. As an example, when differentiating between a fire engine and a car, the fire engine will have different components or parts than the car. These different parts or structural representations will provide different visual concepts. For example, a fire engine may typically be painted the color red. Also, the windows, doors and tires on a fire engine will have different sizes, shapes and spatial relationships relative to similar parts found on a car. The spatial relationships between these visual concepts can be utilized to generate explanations.

As another example, the spatial distance between the side windows of a car to its front wheels will be different than the spatial distance between the side windows of a fire engine to its front wheels. When the output 106 is a prediction on whether the input 102 is a car or a fire truck, the explanation output 110 might also include information on the spatial distance between the side window and the front wheels. For example, if this spatial distance is determined to exceed a pre-determined distance, this determination may correlate to a prediction output 106 of a fire engine. Thus, the explanation output 110 could include information such as the determined color, the determined tire size and the determined spatial distance to explain the underlying decision logic of the machine learning module 104 in generating the output 106.

One possible implementation of the apparatus 100 is in a computer assisted medical diagnosis system. As an example, a computer assisted medical diagnosis system generates diagnosis-related predictions. When the apparatus 100 is implemented in such a system, the apparatus 100 can provide reasoning or evidence to support the generated diagnosis-related predictions.

Another example of a possible implementation of the apparatus 100 is in a quality control system. For example, a quality control system can be configured to generate quality assessment of a product. By implementing the apparatus 100 in such a system, the reasoning or evidence to support the generated assessment can also be provided. For example, this can also include identifying which part of the product failed the test and the severity of the failure.

In one embodiment, either alone or in combination with any one or more of the embodiments described herein, the identified casual relationships can be used to evaluate the performance of a machine learning algorithm on a first process. By revealing or explaining the reasoning logics of the algorithm, the user can intuitively verify whether the outputs are consistent with their understanding. If not, it needs to be determined whether there are inconsistencies due to misunderstandings or false assumptions in the algorithm. The user can then grade the performance of the algorithm.

In one embodiment, either alone or in combination with any one or more of the embodiments described herein, the identified casual relationships can be used to identify defects, limitations or other kinds of shortcomings of the machine learning algorithm on the first process. For example, one of the top visual concepts of fire engines could be the wheels. However, other types of trucks also have wheels, which can look similar to the wheels found on a fire truck. This potentially indicates that the machine learning module 104 may confuse between different trucks and fire trucks. Thus, if the top identifier of fire truck is the wheels, and an image of a truck with similar wheels is the input 102, the output 106 will likely predict the input image 102 as a fire engine, which is an incorrect or inaccurate prediction.

In one embodiment, either alone or in combination with any one or more of the embodiments described herein, the identified casual relationships can be corrected, either automatically by another algorithm, or manually by a user. Generally, this would occur when the output 106 is an incorrect prediction, based on the input 104. The correction can then be used to improve the performance of the machine learning algorithm. For example, a user identifies a visual concept in the representation of an input image that should not be associated with the class of interest. This visual concept can potentially create confusions when the algorithm of the machine learning module 104 is generating predictions with unseen images. The user in this case can remove that visual concept from the representation and transfer the knowledge back to the algorithm by, for example, knowledge distillation.

In one embodiment, either alone or in combination with any one or more of the embodiments described herein, the identified casual relationships can be used as constraints, guidance, supervision, or auxiliary information in the training of other machine learning algorithms. After the second processor 204 learns the reasoning logic from machine learning algorithm 104 running on or being executed by the first processor 202, the knowledge and representation with respect to classes of interest are agnostic of the underlying algorithms. Thus, the machine learning algorithms, such as machine learning algorithm 104, can be transferred to or used to train, other different algorithms with the same task objectives.

In one embodiment, either alone or in combination with any one or more of the other embodiments described herein, the casual relationships generated by the second processor 204 are based on imitative training of another machine learning algorithm with access to the machine learning algorithm in the first processor 202. This means that the second processor 204 has learned to generate the same or very similar predictions compared to the machine learning algorithm 104 run by the first processor 202, given the same input 102.

In one embodiment, either alone or in combination with any one or more of the embodiments described herein, the causal explanations generated by the second processor 204 can be used to extend the application capabilities or functionalities of the machine learning algorithm 104 run by the first processor 202. In the case where there are multiple algorithms targeting different tasks, the second processor 204 can learn the reasoning logics from the multiple algorithms and transfer the cumulative knowledge back to the single algorithm 104 run by the first processor 202. This learning and training process will extend the capability of the machine learning algorithm 104. For example, initially the machine learning algorithm 104 is trained and can recognize ten different categories of objects. After the second processor 204 has learned the reasoning logic, this information can be used by the machine learning algorithm 104 and enable it to recognize more categories of objects, such as twenty for example.

Since concept graphs are used to represent different categories, adjustments can be made to existing concept graphs, by for example, removing or replacing some of the concepts or removing or editing the edges, to represent new objects. As an example, by editing the concept graph for bus, the user can create the concept graph for a fire engine. This way the user can define representations for new objects which can then be “distilled” and transferred to machine learning algorithm 104 so that the machine learning algorithm 104 learns to encode these objects.

Referring again to FIG. 2, the processors 202 and 204, generally referred to as “processors” herein for ease of explanation, generally include suitable logic, circuitry, interfaces and/or code that is configured to process data provided as an input, such as the input 102 and output 106. The processors are configured to respond to and process instructions that drive the apparatus 100. Examples of the processors 202 and 204 can include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Optionally, the processors 202 and 204 may be one or more individual processors, processing devices and various elements associated with a processing device that may be shared by other processing devices. Additionally, the one or more individual processors, processing devices and elements are arranged in various architectures for responding to and processing the instructions that drive the apparatus 100.

In one aspect, the disclosed embodiments include a training phase and an operational phase. In the training phase, the prediction explanation module 108 is trained, using training data, to enable the prediction explanation module 108 to perform specific intended functions in the operational phase. In one embodiment, the second processor 204 is configured to execute an unsupervised or a semi-supervised training of the prediction explanation module 108 using training data to obtain a trained prediction explanation module 108. In the unsupervised training of the prediction explanation module 108, unlabeled training data is used for training of the prediction explanation module 108. Moreover, in the semi-supervised training of the prediction explanation module 108, a comparatively small amount of labeled training data and a large amount of unlabeled training data is used for training of the prediction explanation module 108.

Based on the training of the prediction explanation module 108, a trained prediction explanation module 108 is obtained which is used in the operational stage of the apparatus 100.

Referring again to FIG. 2, in one embodiment the network interface 208 can be configured to include or comprise a medium through which the machine learning module 104, the prediction explanation module 108, as well as other connected devices, can communicate with each other. The communication network, not shown, may be a wired or wireless communication network. Examples of suitable communication networks can include, but are not limited to, a Wireless Fidelity (Wi-Fi) network, a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), a Metropolitan Area Network (MAN), and/or the Internet. The devices of the system or apparatus 100 are potentially configured to connect to the communication network, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, Long Term Evolution (LTE), Light Fidelity (Li-Fi), and/or other cellular communication protocols or Bluetooth (BT) communication protocols, including variants thereof.

Referring also to FIG. 2, in operation, the processor 204 is configured to obtain the output 106 from the machine learning module 104. In one embodiment, the processor 204 receives output 106 via the communication network 508 or any other suitable communication connection. In one embodiment, the processor 204 is configured to store the received output 106 in a suitable memory 206 or other storage device of the apparatus 100.

The memory 206 may comprise suitable logic, circuitry, interfaces, and/or code that may be configured to store instructions executable by the processors 202, 204. The memory 206 is further configured to store operating systems and associated applications of the apparatus 100, including the prediction explanation module 108. Examples of implementation of the memory 206 may include, but are not limited to, Random Access Memory (RAM), Read Only Memory (ROM), Hard Disk Drive (HDD), Flash memory, and/or a Secure Digital (SD) card. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

The network interface 208 includes suitable logic, circuitry, and/or interfaces that is configured to communicate with one or more external devices, such as an electronic device (such as a smartphone). Examples of the network interface 208 may include, but is not limited to, a radio frequency (RF) transceiver, an antenna, a telematics unit, one or more amplifiers, one or more oscillators, a digital signal processor, a coder-decoder (CODEC) chipset, and/or a subscriber identity module (SIM) card. Optionally, the network interface 204 may communicate by use of various wired or wireless communication protocols.

Various embodiments and variants disclosed above, with respect to the aforementioned apparatus or system 100, apply mutatis mutandis to the method. The method described herein is computationally efficient and does not cause processing burden on the processor 202, 204.

Modifications to embodiments of the aspects of the disclosed embodiments described in the foregoing are possible without departing from the scope of the aspects of the disclosed embodiments as defined by the accompanying claims. Expressions such as “including”, “comprising”, “incorporating”, “have”, “is” used to describe and claim the aspects of the disclosed embodiments are intended to be construed in a non-exclusive manner, namely allowing for items, components or elements not explicitly described also to be present. Reference to the singular is also to be construed to relate to the plural.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for automatically generating an explanation for a decision prediction from a machine learning algorithm, the method comprising:
using a first hardware processor of a computing device to run the machine learning algorithm using one or more input data;
generating a decision prediction output based on the one or more input data;
using a second hardware processor to access the decision prediction output of the first hardware processor;
generating additional information that identifies one or more causal relationships between the prediction of the first algorithm and the one or more input data; and
providing the additional information as the explanation in a user-understandable format on a display of the computing device.

2. The method according to claim 1, wherein generating the additional information further comprises:
identifying primitive concepts in the input data;
establishing a representation for objects-of-interest using the identified primitive concepts and relationships between the objects-of-interest;
calculating correlations between the decision prediction output and each component in the representation;
converting the calculated correlations to causal importance scores; and
presenting a visualization of the casual importance scores on a user interface of the computing device.

3. The method according to claim 1, wherein the second hardware processor has access to the machine learning algorithm being run by the first hardware processor.

4. The method according to claim 1, wherein the second hardware processor does not have access to the machine learning algorithm being run by the first hardware processor.

5. The method according to claim 1, wherein the second hardware processor has access to the one or more input data.

6. The method according to claim 1, the second hardware processor does not have access to the one or more input data.

7. The method according to claim 1, wherein the causal relationships comprise spatial correlations between the output of the machine learning algorithm from the first hardware processor and the input data.

8. The method according to claim 1, wherein the causal relationships comprise temporal correlations between the output of the machine learning algorithm from the first hardware processor and the input data.

9. The method according to claim 1, wherein the causal relationships comprise a structural representation of different components sharing causal relationships with the input data or the output of the machine learning algorithm.

10. The method according to claim 1, the method further comprising using the identified casual relationships to evaluate the performance of the machine learning algorithm on a first process.

11. An apparatus for automatically generating an explanation for a decision prediction from a machine learning algorithm, the apparatus comprising:
a first hardware processor of a computing device configured to run the machine learning algorithm using one or more input data and generate a decision prediction output based on the one or more input data;
a second hardware processor configured to access the decision prediction output of the first hardware processor and generate additional information that identifies one or more causal relationships between the prediction output of the first algorithm and the one or more input data; and
a user interface configured to provide the additional information as the explanation in a user-understandable format.

12. The apparatus according to claim 11, wherein the second hardware processor is configured to generate the additional information by:
identifying primitive concepts in the one or more input data;
establishing a representation for objects-of-interest using the identified primitive concepts and relationships between the objects-of-interest;
calculating correlations between the prediction output and each component in the representation;
converting the calculated correlations to causal importance scores; and
presenting a visualization of the casual importance scores on the user interface.

13. The apparatus according to claim 11, wherein the second hardware processor has access to the machine learning algorithm being run by the first hardware processor.

14. The apparatus according to claim 11, wherein the second hardware processor does not have access to the machine learning algorithm being run by the first hardware processor.

15. The apparatus according to claim 11, wherein the second hardware processor has access to the one or more input data.

16. The apparatus according to claim 11, wherein the second hardware processor does not have access to the one or more input data.

17. The apparatus according to claim 11, wherein the causal relationships comprise spatial correlations between the output of the machine learning algorithm from the first hardware processor and the input data.

18. The apparatus according to claim 11, wherein the causal relationships comprise temporal correlations between the output of the machine learning algorithm from the first hardware processor and the input data.

19. The apparatus according to claim 11, wherein the causal relationships comprise a structural representation of different components sharing causal relationships with the input data or the output of the machine learning algorithm.

20. A computer program product comprising a non-transitory computer-readable medium having machine-readable instructions stored thereon, which when executed by a computer causes the computer to generate an explanation for a decision prediction from a machine learning algorithm by:
using a first hardware processor of a computing device to run the machine learning algorithm using one or more input data;
generating a decision prediction output based on the one or more input data;
using a second hardware processor to access the decision prediction output of the first hardware processor;
generating additional information that identifies one or more causal relationships between the prediction output of the first algorithm and the one or more input data; and
providing the additional information as the explanation in a user-understandable format on a display of the computing device.
